(19) United States
(12) Patent Application Publication
(10) Pub. No.: US 2016/0335432 A1
(43) Pub. Date: Nov. 17, 2016

(54) Cascading Classifiers For Computer Security Applications

(71) Applicant: Bitdefender IPR Management Ltd., Nicosia (CY)

(72) Inventors: Cristina VATAMANU, Pascani (RO); Doina COSOVAN, Iasi (RO); Dragos T. GAVRILUT, Iasi (RO); Henri LUCHIAN, Iasi (RO)

(21) Appl. No.: 14/714,718

(22) Filed: May 18, 2015

Related U.S. Application Data
(60) Provisional application No. 62/162,781, filed on May 17, 2015.

(51) Int. Cl. G06F 21/55; G06N 99/00; G06F 21/56

(52) U.S. Cl. CPC G06F 21/552; G06F 21/56; G06N 99/005; G06F 2221/034; G06F 2221/033

(57) ABSTRACT

Described systems and methods allow a computer security system to automatically classify target objects using a cascade of trained classifiers, for applications including malware, spam, and/or fraud detection. The cascade comprises several levels, each level including a set of classifiers. Classifiers are trained in the predetermined order of their respective levels. Each classifier is trained to divide a corpus of records into a plurality of record groups so that a substantial proportion (e.g., at least 95%, or all) of the records in one such group are members of the same class. Between training classifiers of consecutive levels of the cascade, a set of training records of the respective group is discarded from the training corpus. When used to classify an unknown target object, some embodiments employ the classifiers in the order of their respective levels.

### BACKGROUND

The invention relates to systems and methods for training an automated classifier for computer security applications such as malware detection.

Malicious software, also known as malware, affects a great number of computer systems worldwide. In its many forms such as computer viruses, worms, Trojan horses, and rootkits, malware presents a serious risk to millions of computer users, making them vulnerable to loss of data, identity theft, and loss of productivity, among others. The frequency and sophistication of cyber-attacks have risen dramatically in recent years. Malware affects virtually every computer platform and operating system, and every day new malicious agents are detected and identified.

Computer security software may be used to protect users and data against such threats, for instance to detect malicious agents, incapacitate them and/or to alert the user or a system administrator. Computer security software typically relies on automated classifiers to determine whether an unknown object is benign or malicious, according to a set of characteristic features of the respective object. Such features may be structural and/or behavioral. Automated classifiers may be trained to identify malware using various machine-learning algorithms.

A common problem of automated classifiers is that a rise in the detection rate is typically accompanied by a rise in the number of classification errors (false positives and/or false negatives). False positives, e.g., legitimate objects falsely identified as malicious, may be particularly undesirable since such labeling may lead to data loss or to a loss of productivity for the user. Another difficulty encountered during training of automated classifiers is the substantial computational expense required to process a large training corpus, which in the case of computer security applications may consist of several millions of records.

There is substantial interest in developing new classifiers and training methods which are capable of quickly processing large amounts of training data, while ensuring a minimal rate of false positives.

### SUMMARY

According to one aspect, a computer system comprises a hardware processor and a memory. The hardware processor is configured to employ a trained cascade of classifiers to determine whether a target object poses a computer security threat. The cascade of classifiers is trained on a training corpus of records, the training corpus pre-classified into at least a first class and a second class of records. Training of the cascade comprises training a first classifier of the cascade to divide the training corpus into a first plurality of record groups according to a predetermined first threshold so that a first share of records of a first group of the first plurality of record groups belongs to the first class, the first share chosen to exceed the first threshold. Training the cascade further comprises training a second classifier of the cascade to divide the training corpus, including the first group, into a second plurality of record groups according to a predetermined second threshold so that a second share of records of a second group of the second plurality of record groups belongs to the second class, the second share chosen to exceed the second threshold. Training the cascade further comprises, in response to training the first and second classifiers, removing a set of records from the training corpus to produce a reduced training corpus, the set of records selected from the first and second groups. Training the cascade further comprises, in response to removing the set of records, training a third classifier of the cascade to divide the reduced training corpus into a third plurality of record groups according to a predetermined third threshold so that a third share of records of a third group of the third plurality of record groups belongs to the first class, the third share chosen to exceed the third threshold. Training the cascade further comprises, in response to removing the set of records, training a fourth classifier of the cascade to divide the reduced training corpus, including the third group, into a fourth plurality of record groups according to a predetermined fourth threshold so that a fourth share of records of a fourth group of the fourth plurality of record groups belongs to the second class, the fourth share chosen to exceed the fourth threshold.

According to another aspect, a computer system comprises a hardware processor and a memory. The hardware processor is configured to train a cascade of classifiers for use in detecting computer security threats. The cascade of classifiers is trained on a training corpus of records, the training corpus pre-classified into at least a first class and a second class of records. Training of the cascade comprises training a first classifier of the cascade to divide the training corpus into a first plurality of record groups according to a predetermined first threshold so that a first share of records of a first group of the first plurality of record groups belongs to the first class, the first share chosen to exceed the first threshold. Training the cascade further comprises training a second classifier of the cascade to divide the training corpus, including the first group, into a second plurality of record groups according to a predetermined second threshold so that a second share of records of a second group of the second plurality of record groups belongs to the second class, the second share chosen to exceed the second threshold. Training the cascade further comprises, in response to training the first and second classifiers, removing a set of records from the training corpus to produce a reduced training corpus, the set of records selected from the first and second groups. Training the cascade further comprises, in response to removing the set of records, training a third classifier of the cascade to divide the reduced training corpus into a third plurality of record groups according to a predetermined third threshold so that a third share of records of a third group of the third plurality of record groups belongs to the first class, the third share chosen to exceed the third threshold. Training the cascade further comprises, in response to removing the set of records, training a fourth classifier of the cascade to divide the reduced training corpus, including the third group, into a fourth plurality of record groups according to a predetermined fourth threshold so that a fourth share of records of a fourth group of the fourth plurality of record groups belongs to the second class, the fourth share chosen to exceed the fourth threshold.

According to another aspect, a non-transitory computer-readable medium stores instructions which, when executed by at least one hardware processor of a computer system, cause the computer system to employ a trained cascade of classifiers to determine whether a target object poses a computer security threat. The cascade of classifiers is trained on a training corpus of records, the training corpus pre-classified into at least a first class and a second class of records. Training of the cascade comprises training a first classifier of the cascade to divide the training corpus into a first plurality of record groups according to a predetermined first threshold so that a first share of records of a first group of the first plurality of record groups belongs to the first class, the first share chosen to exceed the first threshold. Training the cascade further comprises training a second classifier of the cascade to divide the training corpus, including the first group, into a second plurality of record groups according to a predetermined second threshold so that a second share of records of a second group of the second plurality of record groups belongs to the second class, the second share chosen to exceed the second threshold. Training the cascade further comprises, in response to training the first and second classifiers, removing a set of records from the training corpus to produce a reduced training corpus, the set of records selected from the first and second groups. Training the cascade further comprises, in response to removing the set of records, training a third classifier of the cascade to divide the reduced training corpus into a third plurality of record groups according to a predetermined third threshold so that a third share of records of a third group of the third plurality of record groups belongs to the first class, the third share chosen to exceed the third threshold. Training the cascade further comprises, in response to removing the set of records, training a fourth classifier of the cascade to divide the reduced training corpus, including the third group, into a fourth plurality of record groups according to a predetermined fourth threshold so that a fourth share of records of a fourth group of the fourth plurality of record groups belongs to the second class, the fourth share chosen to exceed the fourth threshold.

### BRIEF DESCRIPTION OF THE DRAWINGS

The foregoing aspects and advantages of the present invention will become better understood upon reading the following detailed description and upon reference to the drawings where:

FIG. 1 shows an exemplary computer security system according to some embodiments of the present invention.

FIG. 2 illustrates an exemplary hardware configuration of a client system according to some embodiments of the present invention.

FIG. 3 shows an exemplary hardware configuration of a classifier training system according to some embodiments of the present invention.

FIG. 4 illustrates a trainer executing on the classifier training system of FIG. 1 and configured to train a cascade of classifiers according to some embodiments of the present invention.

FIG. 5-A illustrates a feature space divided in two distinct regions by a first classifier of a cascade, according to some embodiments of the present invention.

FIG. 5-B shows another set of regions of the feature space, the regions separated by a second classifier of the cascade according to some embodiments of the present invention.

FIG. 5-C illustrates yet another set of regions of the feature space, the regions separated by a third trained classifier of the cascade according to some embodiments of the present invention.

FIG. 6 illustrates an exemplary sequence of steps performed by the trainer of FIG. 4 according to some embodiments of the present invention.

FIG. 7-A shows an exemplary data transmission between a client system and the classifier training system, in an embodiment of the present invention implementing client-based scanning.

FIG. 7-B illustrates an exemplary data exchange between the client system, security server, and classifier training system, in an embodiment of the present invention implementing cloud-based scanning.

FIG. 8 shows an exemplary security application executing on the client system according to some embodiments of the present invention.

FIG. 9 illustrates a classification of an unknown target object according to some embodiments of the present invention.

FIG. 10 illustrates an exemplary sequence of steps performed by the security application of FIG. 8 to classify an unknown target object according to some embodiments of the present invention.

FIG. 11-A shows training a first level of a classifier cascade on an exemplary training corpus, in an embodiment of the present invention wherein each level of the cascade comprises multiple classifiers.

FIG. 11-B shows training a second level of a classifier cascade having multiple classifiers per level.

FIG. 12 shows an exemplary sequence of steps carried out to train a cascade comprising multiple classifiers per level, according to some embodiments of the present invention.

FIG. 13 shows an exemplary sequence of steps performed to classify an unknown target object in an embodiment of the present invention that uses multiple classifiers per level.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A first number exceeds a second number when the first number is larger than or at least equal to the second number. Computer security encompasses protecting users and equipment against unintended or unauthorized access to data and/or hardware, unintended or unauthorized modification of data and/or hardware, and destruction of data and/or hardware. A computer program is a sequence of processor instructions carrying out a task. Computer programs described in some embodiments of the present invention may be stand-alone software entities or sub-entities (e.g., subroutines, code objects) of other computer programs. Unless otherwise specified, a process is an instance of a computer program, such as an application or a part of an operating system, and is characterized by having at least an execution thread and a virtual memory space assigned to it, wherein a content of the respective virtual memory space includes executable code. Unless otherwise specified, a classifier completely classifies a corpus of records (wherein each record carries a class label) when the respective classifier divides the corpus into distinct groups of records so that all the records of each group have identical class labels. Computer readable media encompass non-transitory storage media such as magnetic, optic, and semiconductor media (e.g. hard drives, optical disks, flash memory, DRAM), as well as communications links such as conductive cables and fiber optic links. According to some embodiments, the present invention provides, inter alia, computer systems comprising hardware programmed to perform the methods described herein, as well as computer-readable media encoding instructions to perform the methods described herein.

The following description illustrates embodiments of the invention by way of example and not necessarily by way of limitation.

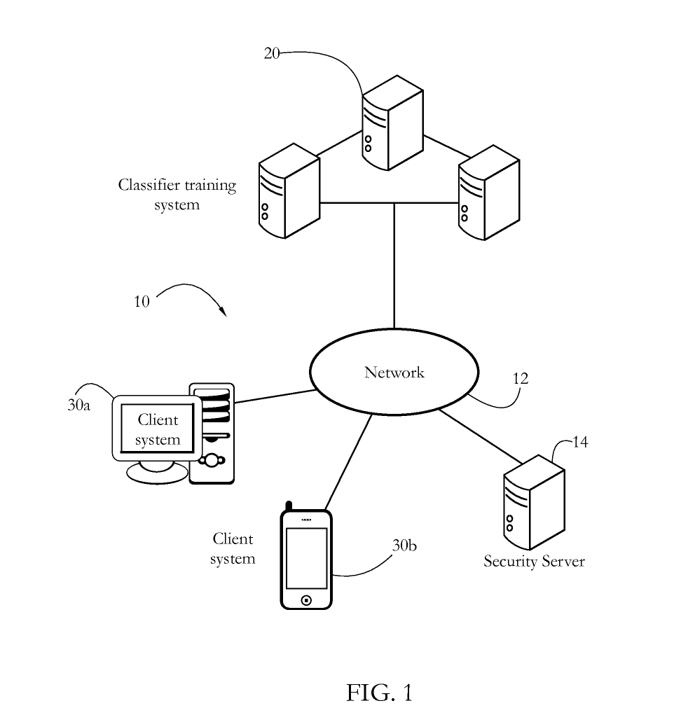

FIG. 1 shows an exemplary computer security system 10 according to some embodiments of the present invention. Computer security system 10 comprises a classifier training system 20, a set of client systems 30a-b, and a security server 14, all interconnected via a network 12. Network 12 may include a local area network (LAN) such as a corporate network, as well as a wide-area network such as the Internet. In some embodiments, client systems 30a-b may represent end-user computers, each having a processor, memory, and storage, and running an operating system such as Windows®, MacOS® or Linux, among others. Other exemplary client systems 30a-b include mobile computing devices (e.g., laptops, tablet PC's), telecommunication devices (e.g., smartphones), digital entertainment appliances (TV's, game consoles, etc.), wearable computing devices (e.g., smartwatches), or any other electronic device having a processor and a memory, and capable of connecting to network 12. Client systems 30a-b may represent individual customers, or several client systems may belong to the same customer.

System 10 may protect client systems 30a-b, as well as users of client systems 30a-b, against a variety of computer security threats, such as malicious software (malware), unsolicited communication (spam), and electronic fraud (e.g., phishing, Nigerian fraud, etc.), among others. Client systems 30a-b may detect such computer security threats using a cascade of classifiers trained on classifier training system 20, as shown in detail below.

In one use case scenario, a client system may represent an email server, in which case some embodiments of the present invention may enable the respective email server to detect spam and/or malware attached to electronic communications, and to take protective action, for instance removing or quarantining malicious items before delivering the respective messages to the intended recipients. In another use-case scenario, each client system 30a-b may include a security application configured to scan the respective client system in order to detect malicious software. In yet another use-case scenario, aimed at fraud detection, each client system 30a-b may include a security application configured to detect an intention of a user to access a remote resource (e.g., a website). The security application may send an indicator of the resource, such as a URL, to security server 14, and receive back a label indicating whether the resource is fraudulent. In such embodiments, security server 14 may determine the respective label using a cascade of classifiers received from classifier training system 20, as shown in detail below.

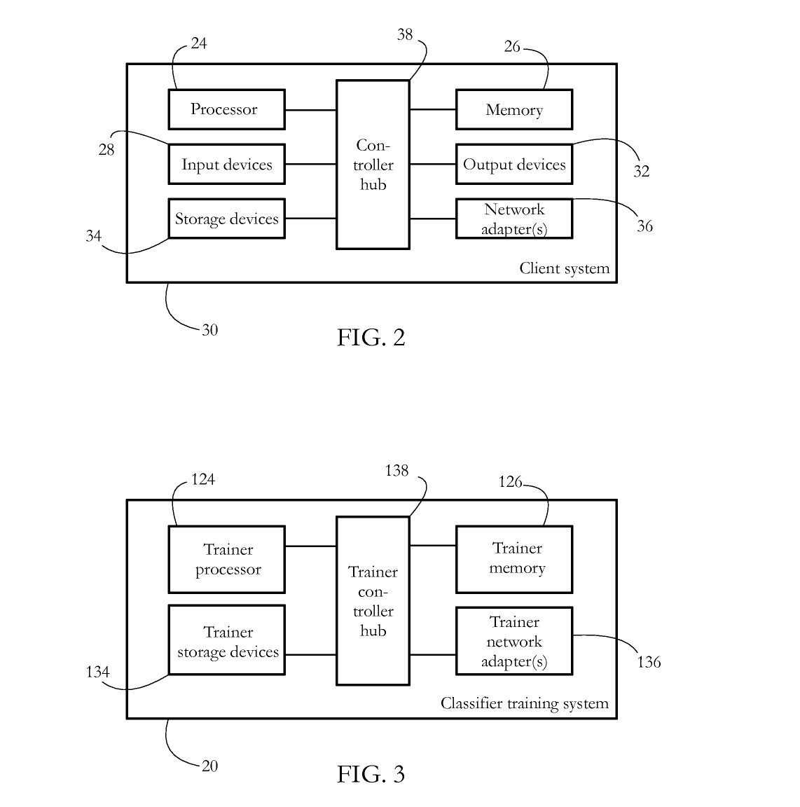

FIG. 2 illustrates an exemplary hardware configuration of a client system 30, such as client systems 30a-b in FIG. 1. While the illustrated client system 30 is a computer system, a skilled artisan will appreciate that the present description may be adapted to other client systems such as tablet PCs, mobile telephones, etc. Client system 30 comprises a set of physical devices, including a hardware processor 24, a memory unit 26, a set of input devices 28, a set of output devices 32, a set of storage devices 34, and a set of network adapters 36, all connected by a controller hub 38.

In some embodiments, processor 24 comprises a physical device (e.g. microprocessor, multi-core integrated circuit formed on a semiconductor substrate) configured to execute computational and/or logical operations with a set of signals and/or data. In some embodiments, such logical operations are transmitted to processor 24 from memory unit 26, in the form of a sequence of processor instructions (e.g. machine code or other type of software). Memory unit 26 may comprise volatile computer-readable media (e.g. RAM) storing data/signals accessed or generated by processor 24 in the course of carrying out instructions. Input devices 28 may include computer keyboards, mice, and microphones, among others, including the respective hardware interfaces and/or adapters allowing a user to introduce data and/or instructions into client system 30. Output devices 32 may include display devices such as monitors and speakers, among others, as well as hardware interfaces/adapters such as graphic cards, allowing client system 30 to communicate data to a user. In some embodiments, input devices 28 and output devices 32 may share a common piece of hardware, as in the case of touch-screen devices. Storage devices 34 include computer-readable media enabling the non-volatile storage, reading, and writing of processor instructions and/or data. Exemplary storage devices 34 include magnetic and optical disks and flash memory devices, as well as removable media such as CD and/or DVD disks and drives. The set of network adapters 36 enables client system 30 to connect to network 12 and/or to other devices/computer systems. Controller hub 38 generically represents the plurality of system, peripheral, and/or chipset buses, and/or all other circuitry enabling the communication between processor 24 and devices 26, 28, 32, 34 and 36. For instance, controller hub 38 may comprise a northbridge connecting processor 24 to memory 26, and/or a southbridge connecting processor 24 to devices 28, 32, 34 and 36.

FIG. 3 shows an exemplary hardware configuration of classifier training system 20, according to some embodiments of the present invention. Training system 20 generically represents a set of computer systems; FIG. 3 represents just one machine for reasons of clarity. Multiple such machines may be interconnected via a part of network 12 (e.g., in a server farm). In some embodiments, training system 20 includes a trainer processor 124, a trainer memory unit 126, a set of trainer storage devices 134, and a set of trainer network adapters 136, all connected by a trainer controller hub 138. Although some details of hardware configuration may differ between training system 20 and client system 30, the operation of devices 124, 126, 134, 136 and 138 may be similar to that of devices 24, 26, 34, 36 and 38 described above, respectively. For instance, trainer processor 124 may include a hardware microprocessor configured to perform logical and/or mathematical operations with signals/data received from trainer memory unit 126, and to write a result of such operations to unit 126.

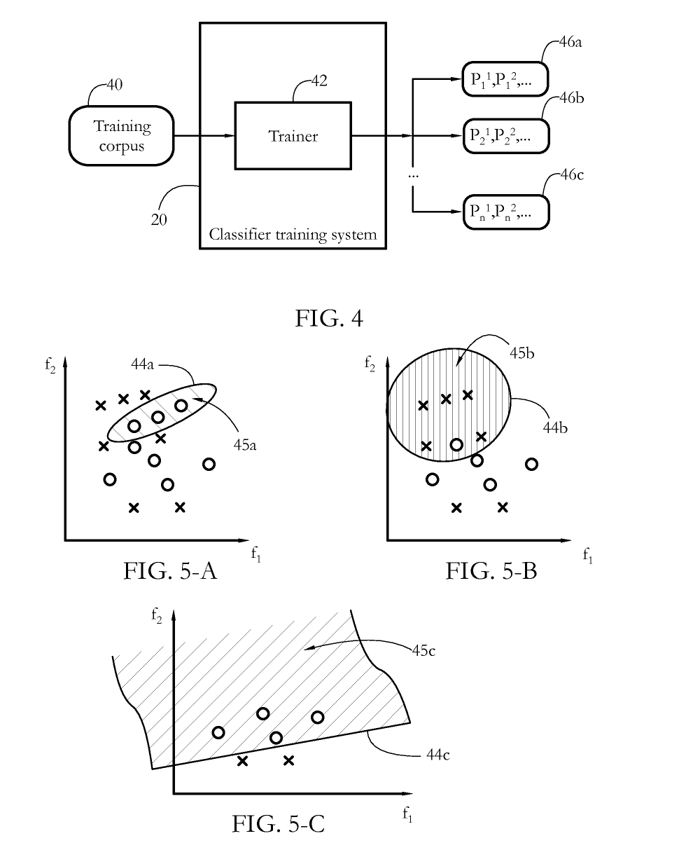

FIG. 4 illustrates a trainer 42 executing on training system 20 and configured to train a cascade of classifiers according to some embodiments of the present invention. The cascade comprises a plurality of classifiers C₁, C₂, . . . Cₙ configured to be used in a specific order. In some embodiments, each classifier of the cascade distinguishes between several distinct groups of objects, for instance, between clean objects and malware, between legitimate email and spam, or between different categories of malware. Such classifiers may include adaptations of various automated classifiers well-known in the art, e.g., naïve Bayes classifiers, artificial neural networks (ANNs), support vector machines (SVMs), k-nearest neighbor classifiers (KNN), clustering classifiers (e.g., using the k-means algorithm), multivariate adaptive regression spline (MARS) classifiers, and decision tree classifiers, among others.

Adapting such a standard classifier for use in an embodiment of the present invention may include, for instance, modifying a cost or penalty function used in the training algorithm so as to encourage configurations wherein the majority of records in a group belong the same class (see further discussion below). An exemplary modification of a perceptron produces a one-sided perceptron, which separates a corpus of records in two groups such that all records within a group have the same class label.

The choice of type of classifier may be made according to particularities of the training data (for instance, whether the data has substantial noise, whether the data is linearly separable, etc.), or to the domain of application (e.g., malware detection, fraud detection, spam detection, etc.). Not all classifiers of the cascade need to be of the same type.

Training the cascade of classifiers proceeds according to performance criteria and methods detailed below. In some embodiments, the output of trainer 42 (FIG. 4) includes a plurality of classifier parameter sets 46a-c, each such parameter set used to instantiate a classifier C₁, C₂, . . . Cₙ of the cascade. In one example of an artificial neural network classifier (e.g., a perceptron), parameters 46a-c may include a count of layers and a set of synapse weights. In the case of support vector machines (SVMs), parameters 46a-c may include an indicator of a choice of kernel function, and/or a set of coefficients of a hypersurface separating two distinct groups of objects in feature space. In the case of a clustering classifier, parameters 46a-c may include coordinates of a set of cluster centers, and a set of cluster diameters. In some embodiments, each parameter sets 46a-c includes an indicator of a classifier type.

Training the cascade of classifiers comprises processing a training corpus 40 (FIG. 4). In some embodiments, corpus 40 comprises a large collection of records (e.g. millions of records). Depending on the domain of application of the present invention, each such record may represent a software object (e.g., a file or computer process), an electronic message, a URL, etc. Training corpus 40 is pre-classified into several classes, for instance, clean and malicious, or spam and legitimate. Such pre-classification may include, for instance, each record of corpus 40 carrying a label indicating a class that the respective record belongs to, the label determined prior to training the cascade of classifiers.

In some embodiments, each record of training corpus 40 is represented as a feature vector, i.e., as a set of coordinates in a feature hyperspace, wherein each coordinate represents a value of a specific feature of the respective record. Such features may depend on the domain of application of the present invention, and may include numeric and/or Boolean features. Exemplary record features include static attributes and behavioral attributes. In the case of malware detection, for instance, exemplary static attributes of a record may include, among others, a file name, a file size, a memory address, an indicator of whether a record is packed, an identifier of a packer used to pack the respective record, an indicator of a type of record (e.g., executable file, dynamic link library, etc.), an indicator of a compiler used to compile the record (e.g., C++, .Net, Visual Basic), a count of libraries loaded by the record, and an entropy measure of the record. Behavioral attributes may indicate whether an object (e.g., process) performs certain behaviors during execution. Exemplary behavioral attributes include, among others, an indicator of whether the respective object writes to the disk, an indicator of whether the respective object attempts to connect to the Internet, an indicator of whether the respective object attempts to download data from remote locations, and an indicator of whether the respective object injects code into other objects during execution. In the case of fraud detection, exemplary record features include, among others, an indicator of whether a webpage comprises certain fraud-indicative keywords, and an indicator of whether a webpage exposes a HTTP form. In the case of spam detection, exemplary record features may include the presence of certain spam-indicative keywords, an indicator of whether a message comprises hyperlinks, and an indicator of whether the respective message contains any attachments. Other exemplary record features include certain message formatting features that are spam-indicative.

FIGS. 5-A-B-C illustrate training a set of exemplary classifiers of the cascade according to some embodiments of the present invention. FIGS. 5-A-B-C may show, for instance, consecutive stages of training the cascade of classifiers, as shown further below. Without loss of generality, the illustrated corpus of records comprises two classes (for instance, circles may represent malicious objects, while crosses may represent benign objects). Each record is represented as a feature vector in a two-dimensional feature space spanned by features f₁ and f₂. A skilled artisan will appreciate that the described systems and methods may be extended to a corpus having more than two classes of records, and/or to higher-dimensional feature spaces.

In some embodiments of the present invention, each classifier of the cascade is trained to divide a current corpus of records into at least two distinct groups, so that a substantial share of records within one of the groups have identical class labels, i.e., belong to the same class. Records having identical class labels form a substantial share when the proportion of such records within the respective group exceeds a predetermined threshold. Exemplary thresholds corresponding to a substantial share include 50%, 90%, and 99%, among others. In some embodiments, all records within one group are required to have the same class label; such a situation would correspond to a threshold of 100%. A higher threshold may produce a classifier which is more costly to train, but which yields a lower misclassification rate. The value of the threshold may differ among the classifiers of the cascade.

The operation and/or training of classifiers may be better understood using the feature space representations of FIGS. 5-A-B-C. In FIG. 5-A, a classifier C₁ is trained to distinguish between two groups of records by producing a frontier 44a which divides feature space in two regions, so that each distinct group of records inhabits a distinct region of feature space (e.g., outside and inside frontier 44a). Without loss of generality, exemplary frontier 44a is an ellipse. Such a frontier shape may be produced, for instance, by a clustering classifier; another choice of classifier could produce a frontier of a different shape. A skilled artisan will understand that for some choices of classifier (e.g., a decision tree), such a frontier may not exist or may be impossible to draw. Therefore, the drawings in FIGS. 5A-B-C are shown just to simplify the present description, and are not meant to limit the scope of the present invention.

In some embodiments, training classifier C₁ comprises adjusting parameters of frontier 44a until classification conditions are satisfied. Parameters of the frontier, such as the center and/or diameters of the ellipse, may be exported as classifier parameters 46a (FIG. 4). A substantial share (all) of records inside frontier 44a belong to one class (indicated as circles). The region of feature space inhabited by the group of records having identical labels will be hereinafter deemed a preferred region 45a of classifier C₁. Preferred regions of classifiers C₁, C₂, and C₃ are illustrated as shaded areas in FIGS. 5A-B-C, respectively. The class of the records lying within the preferred region of each classifier will be deemed a preferred class of the respective classifier. In the example of FIG. 5-A, the preferred class of classifier C₁ is circles (e.g., malware).

FIG. 5-B illustrates another set of regions separated in feature space by another frontier 44b, representing a second exemplary trained classifier C₂ of the cascade. In the illustrated example, frontier 44b is again an ellipse; its parameters may be represented, for instance, by parameter set 46b in FIG. 4. FIG. 5-B further shows a preferred region 45b of classifier C₂, the preferred region containing mainly records having identical labels. In the example of FIG. 5-B, the preferred class of classifier C₂ is crosses (e.g., clean, non-malicious).

FIG. 5-C shows yet another set of regions separated in feature space by another frontier 44c, and another preferred region 45c of a third exemplary trained classifier C₃ of the cascade. The illustrated classifier C₃ may be a perceptron, for example. Preferred region 45c contains only circles, i.e., the preferred class of classifier C₃ is circles. In some embodiments, as illustrated in FIGS. 5-A-B-C, a set of records is removed from training corpus 40 between consecutive stages of training, e.g., between training consecutive classifiers of the cascade. The set of records being removed from the corpus is selected from the preferred region of each trained classifier.

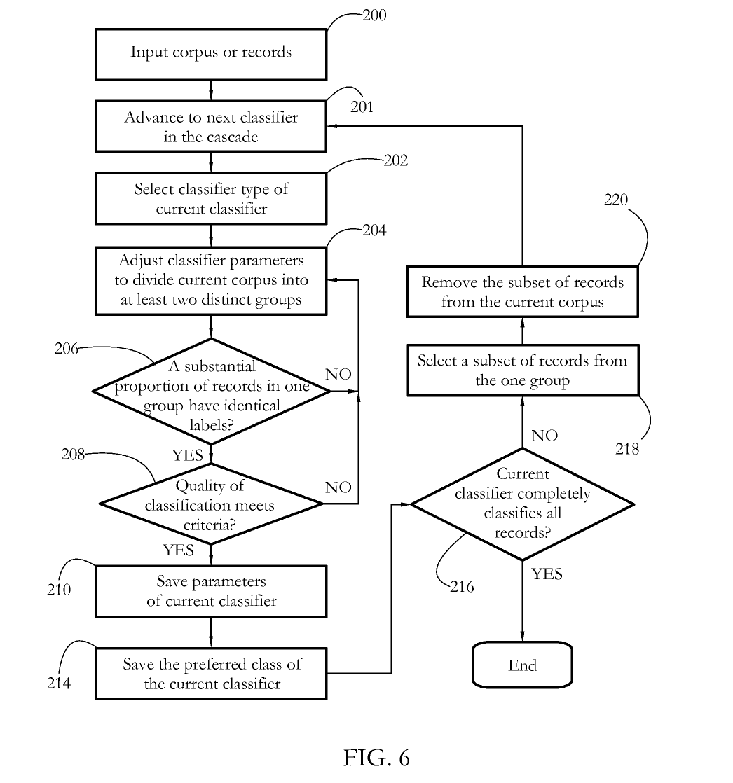

FIG. 6 illustrates an exemplary sequence of steps performed by trainer 42 (FIG. 4) to train the cascade of classifiers according to some embodiments of the present invention. After inputting training corpus 40 (step 200), a sequence of steps 202-220 is repeated in a loop, one such loop executed for each consecutive classifier C₁ of the cascade.

A step 202 selects a type of classifier for training, from a set of available types (e.g., SVM, clustering classifier, perceptron, etc.). The choice of classifier may be made according to performance requirements (speed of training, accuracy of classification, etc.) and/or according to particularities of the current training corpus. For instance, when the current training corpus is approximately linearly separable, step 202 may choose a perceptron. When the current training corpus has concentrated islands of records, a clustering classifier may be preferred. In some embodiments, all classifiers of the cascade are of the same type.

Other classifier selection scenarios are possible. For instance, at each stage of the cascade, some embodiments may try various classifier types and choose the classifier type that performs better according to a set of criteria. Such criteria may involve, among others, the count of records within the preferred region, the accuracy of classification, and the count of misclassified records. Some embodiments may apply a cross-validation test to select the best classifier type. In yet another scenario, the type of classifier is changed from one stage of the cascade to the next (for instance in an alternating fashion). The motivation for such a scenario is that as the training corpus is shrinking from one stage of the cascade to the next by discarding a set of records, it is possible that the nature of the corpus changes from a predominantly linearly-separable corpus to a predominantly insular corpus (or vice versa) from one stage of the cascade to the next. Therefore, the same type of classifier (e.g., a perceptron) may not perform as well in successive stages of the cascade. In such scenarios, the cascade may alternate, for instance, between a perceptron and a clustering classifier, or between a perceptron and a decision tree.

A sequence of steps 204-206-208 effectively trains the current classifier of the cascade to classify the current training corpus. In some embodiments, training the current classifier comprises adjusting the parameters of the current classifier (step 204) until a set of training criteria is met. The adjusted set of classifier parameters may indicate a frontier, such as a hypersurface, separating a plurality of regions of feature space (see e.g., FIGS. 5-A-B-C) from each other.

One training criterion (enforced in step 206) requires that a substantial share of the records of the current training corpus lying in one of the said regions have the same label, i.e., belong to one class. In some embodiments, the respective preferred class is required to be the same for all classifiers of the cascade. Such classifier cascades may be used as filters for records of the respective preferred class. In an alternative embodiment, the preferred class is selected so that it cycles through the classes of training corpus. For instance, in a two-class corpus (e.g., malware and clean), the preferred class of classifiers C₁, C₃, C₅, . . . may be malware, while the preferred class of classifies C₂, C₄, C₆, . . . may be clean. In other embodiments, the preferred class may vary arbitrarily from one classifier of the cascade to the next, or may vary according to particularities of the current training corpus.

Step 206 may include calculating a proportion (fraction) of records within one group distinguished by the current classifier, the respective records belonging to the preferred class of the current classifier, and testing whether the fraction exceeds a predetermined threshold. When the fraction does not exceed the threshold, execution may return to step 204. Such training may be achieved using dedicated classification algorithms or well-known machine learning algorithms combined with a feedback mechanism that penalizes configurations wherein the frontier lies such that each region hosts mixed records from multiple classes.

In some embodiments, a step 208 verifies whether other training criteria are met. Such criteria may be specific to each classifier type. Exemplary criteria may be related to the quality of classification, for instance, may ensure that the distinct classes of the current training corpus be optimally separated in feature space. Other exemplary criteria may be related to the speed and/or efficiency of training, for instance may impose a maximum training time and/or a maximum number of iterations for the training algorithms. Another exemplary training criterion may require that the frontier be adjusted such that the number of records having identical labels and lying within one of the regions is maximized. Other training criteria may include testing for signs of over-fitting and estimating a speed with which the training algorithm converges to a solution.

When training criteria are met for the current classifier, in a step 210, trainer 42 saves the parameters of the current classifier (e.g., items 46a-c in FIG. 4). A further step 214 saves the preferred class of the current classifier.

In some embodiments, a step 216 determines whether the current classifier completely classifies the current corpus, i.e., whether the current classifier divides the current corpus into distinct groups so that all records within each distinct group have identical labels (see, e.g., FIG. 5-C). When yes, training stops. When no, a sequence of steps 218-220 selects a set of records and removes said set from the current training corpus. In some embodiments, the set of records selected for removal is selected from the preferred region of the current classifier. In one such example, step 220 removes all records of the current corpus lying within the preferred region of the current classifier (see FIGS. 5-A-B-C).

In some embodiments operating as shown in FIG. 6, the actual count of classifiers in the cascade is known only at the end of the training procedure, when all the records of the current corpus are completely classified. In an alternative embodiment, the cascade may comprise a fixed, pre-determined number of classifiers, and training may proceed until all classifiers are trained, irrespective of whether the remaining training corpus is completely classified or not.

Once the training phase is completed, the cascade of classifiers trained as described above can be used for classifying an unknown target object 50. In an anti-malware exemplary application of the present invention, such a classification may determine, for instance, whether target object 50 is clean or malicious. In other applications, such a classification may determine, for instance, whether the target object is legitimate or spam, etc. The classification of target object 50 may be performed on various machines and in various configurations, e.g., in combination with other security operations.

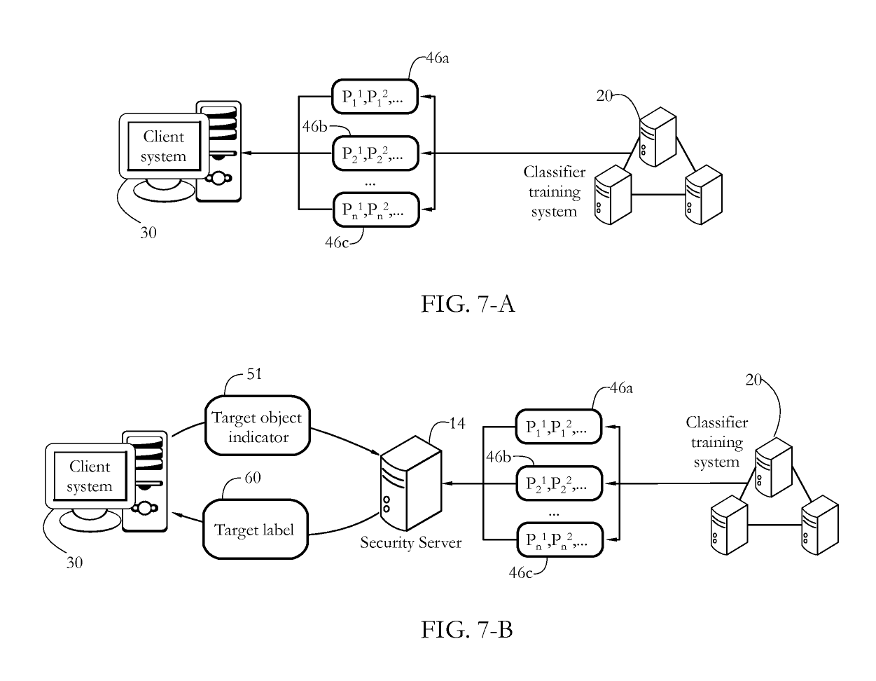

In some embodiments, classification is done at client system 30 (client-based scanning), or at security server 14 (cloud-based scanning) FIG. 7-A shows an exemplary data transmission, where computed classifier parameters 46a-c are being sent from classifier training system 20 to client system 30 for client-based scanning. In contrast to FIG. 7-A, FIG. 7-B shows a cloud-based scanning configuration, wherein parameters 46a-c are sent to security server 14. In such configurations, client system 30 may send to security server 14 a target object indicator 51 indicative of target object 50, and in response, receive from server 14 a target label 60 indicating a class membership of target object 50. Indicator 51 may comprise the target object itself, or a subset of data characterizing target object 50. In some embodiments, target object indicator 51 comprises a feature vector of target object 50.

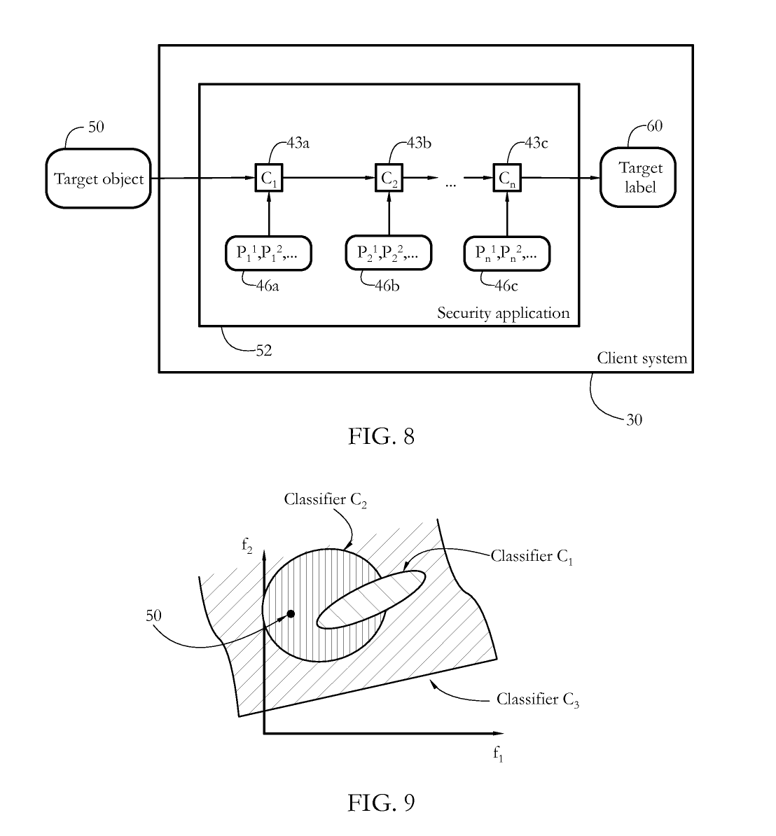

For clarity, FIGS. 8-9-10 will describe only client-based scanning (i.e., according to the configuration of FIG. 7-A), but a skilled artisan will appreciate that the described method can also be applied to cloud-based scanning. Also, the following description will focus only on anti-malware applications. However, the illustrated systems and methods may be extended with minimal modifications to other security applications such as anti-spam, anti-fraud, etc., as well as to more general applications such as document classification, data mining, etc.

FIG. 8 shows an exemplary security application 52 executing on client system 30 according to some embodiments of the present invention. Client system 30 may include a security application 52 which in turn includes a cascade of classifiers C₁, . . . Cₙ instantiated with parameters 46a-c. Security application 52 is configured to receive target object 50 and to generate target label 60 indicating, among others, a class membership of target object 50 (e.g. clean or malicious). Application 52 may be implemented in a variety of manners, for instance, as a component of a computer security suite, as a browser plugin, as a component of a messaging application (e.g., email program), etc.

In some embodiments, the cascade of classifiers C₁, . . . Cₙ is an instance of the cascade trained as described above, in relation to FIG. 6. For instance, classifier C₁ represents the first trained classifier of the cascade (instantiated with parameters 46a), classifier C₂ represents the second trained classifier of the cascade (instantiated with parameters 46b), etc. In some embodiments, application 52 is configured to apply classifiers C₁, . . . Cₙ in a predetermined order (e.g., the order in which the respective classifiers were trained) to discover the class assignment of target object 50, as shown in more detail below.

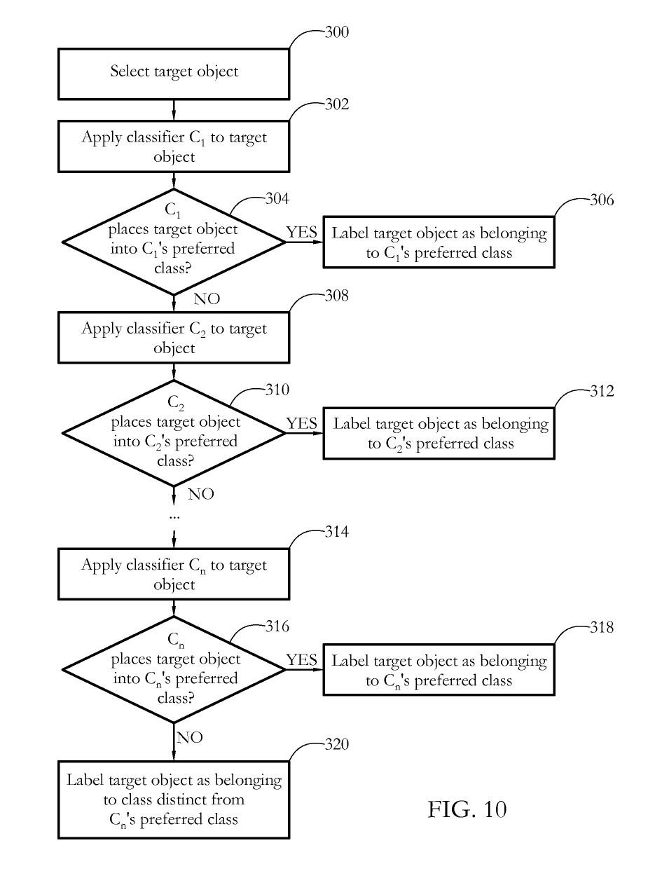

FIGS. 9-10 illustrate an exemplary classification of target object 50 according to some embodiments of the present invention. FIG. 9 shows preferred regions of the classifiers illustrated in FIGS. 5-A-B-C, with a feature vector representing target object 50 lying within the preferred region of the second classifier.

FIG. 10 shows an exemplary sequence of steps performed by security application 52 according to some embodiments of the present invention. In a step 300, target object 50 is chosen as input for security application 52. In an anti-malware embodiment, exemplary target objects 50 may include, among others, an executable file, a dynamic link library (DLL), and a content of a memory section of client system 30. For instance, for a client system running Microsoft Windows®, target objects 50 may include executable files from the WINDIR folder, executables from the WINDIR/system32 folder, executables of the currently running processes, DLLs imported by the currently running processes, and executables of installed system services, among others. Similar lists of target objects may be compiled for client systems 30 running other operating systems, such as Linux®. Target object 50 may reside on computer readable media used by or communicatively coupled to client system 30 (e.g. hard drives, optical disks, DRAM, as well as removable media such as flash memory devices, CD and/or DVD disks and drives). Step 300 may further include computing a feature vector of target object 50, the feature vector representing object 50 in feature space.

In a step 302, security application 52 employs classifier C₁ to classify target object 50. In some embodiments, step 302 comprises determining a frontier in feature space, for instance according to parameters 46a of classifier C₁, and determining on which side of the respective frontier (i.e., in which classification region) the feature vector of target object 50 lies. In a step 304, security application 52 determines whether classifier C₁ places the target object into C₁'s preferred class. In some embodiments, step 304 may include determining whether the feature vector of target object 50 falls within classifier's C₁ preferred region. When no, the operation of application proceeds to a step 308 described below. When yes, in step 306, target object 50 is labeled as belonging to the preferred class of classifier C₁. In the exemplary configuration illustrated in FIG. 9, target object 50 is not within the preferred region of classifier C₁.

In step 308, security application 52 applies the second classifier C₂ of the cascade to classify target object 50. A step 310 determines whether classifier C₂ places the target object into C₂'s preferred class (e.g., whether the feature vector of target object 50 falls within the preferred region of classifier C₂). When yes, in a step 312, target object 50 is assigned to the preferred class of classifier C₂. This situation is illustrated in FIG. 9.

Security application 52 successively applies classifiers C₁ of the cascade, until the target object is assigned to a preferred class of one of the classifiers. When no classifier of the cascade recognizes the target object as belonging to their respective preferred class, in a step 320, target object 50 is assigned to a class distinct from the preferred class of the last classifier Cₙ of the cascade. For example, in a two-class embodiment, when the preferred class of the last classifier is “clean”, target object 50 may be assigned to the “malicious” class, and vice versa.

The above description focused on embodiments of the present invention, wherein the cascade comprises a single classifier for each level of the cascade. Other embodiments of the cascade, described in detail below, may include multiple classifiers per level. For the sake of simplicity, the following discussion considers that the training corpus is pre-classified into two distinct classes A and B (e.g., malicious and benign), illustrated in the figures as circles and crosses, respectively. An exemplary cascade of classifiers trained on such a corpus may comprise two distinct classifiers, Cᵢ^{(A)} and Cᵢ^{(B)}, for each level i=1, 2, . . . , n of the cascade. A skilled artisan will understand how to adapt the description to other types cascades and/or training corpuses. For instance, a cascade may comprise, at each level, at least one classifier for each class of records of the training corpus. In another example, each level of the cascade may comprise two classifiers, each trained to preferentially identify records of a distinct class, irrespective of the count of classes of the training corpus. In yet another example, the count of classifiers may differ from one level of the cascade to another.

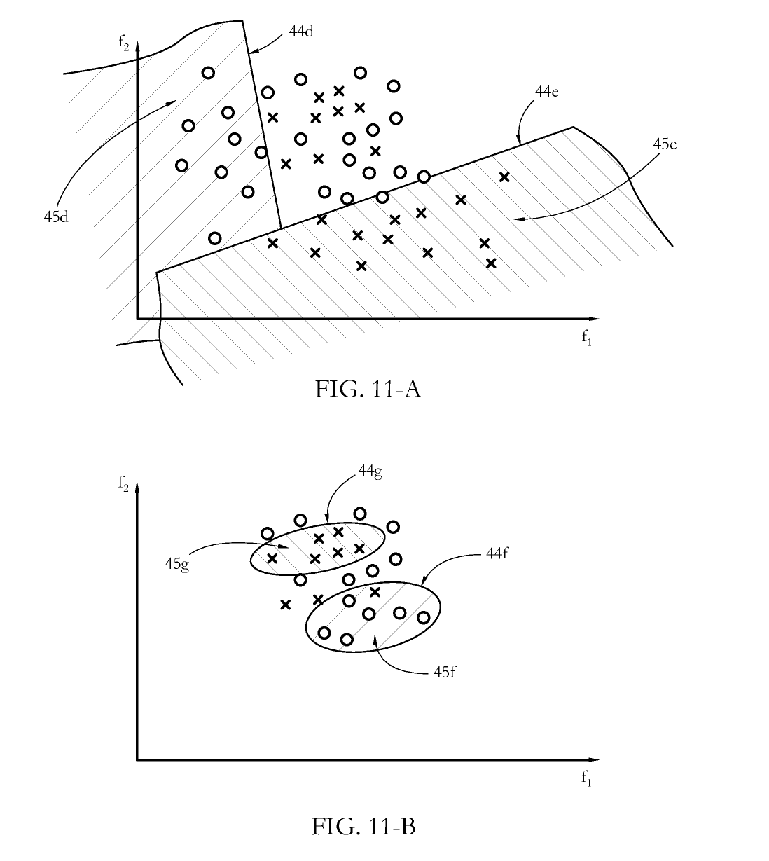

FIG. 11-A shows a two-class training corpus, and two classifiers trained on the respective corpus according to some embodiments of the present invention. For instance, FIG. 11-A may illustrate training of a first level (i=1) of the cascade. Classifier C₁^{(A)} is trained to divide the current corpus into two groups, so that a substantial share of records in one of the groups (herein deemed the preferred group of classifier C₁^{(A)}) belong to class A. In the example of FIG. 11-A, training classifier C₁^{(A)} comprises adjusting parameters of a frontier 44d so that a substantial proportion of records in a preferred region 45d of feature space belong to class A (circles). Classifier C₁^{(B)} is trained on the same corpus as all other classifiers of the respective cascade level, i.e., the same corpus as that used to train C₁^{(A)}. Classifier C₁^{(B)} is trained to divide the current corpus into another pair of record groups, so that a substantial share of records in a preferred group of classifier C₁^{(B)} belong to class B. Training classifier C₁^{(B)} may comprise adjusting parameters of a frontier 44e so that a substantial proportion of records in a preferred region 45e of feature space belong to class B (crosses).

FIG. 11-B illustrates training the subsequent level of the cascade (e.g., i=2). Classifiers C₂^{(A)} and C₂^{(B)} of the second level are trained on a reduced training corpus. In the illustrated example, all records in the preferred groups of classifiers C₁^{(A)} and C₁^{(B)} were discarded from the training corpus in preparation for training classifiers C₂^{(A)} and C₂^{(B)}. In general, a subset of the preferred groups of classifiers C₁^{(A)} and C₁^{(B)} may be discarded from the corpus used to train C₁^{(A)} and C₁^{(B)}. Classifier C₁^{(A)} is trained to identify a preferred group of records of which a substantial share belong to class A. The other classifier of the respective cascade level, C₂^{(B)}, is trained to identify a preferred group of records of which a substantial share belong to class B. In FIG. 11-B, the preferred groups of classifiers C₂^{(A)} and C₂^{(B)} lie within regions 45f-g of feature space, respectively.

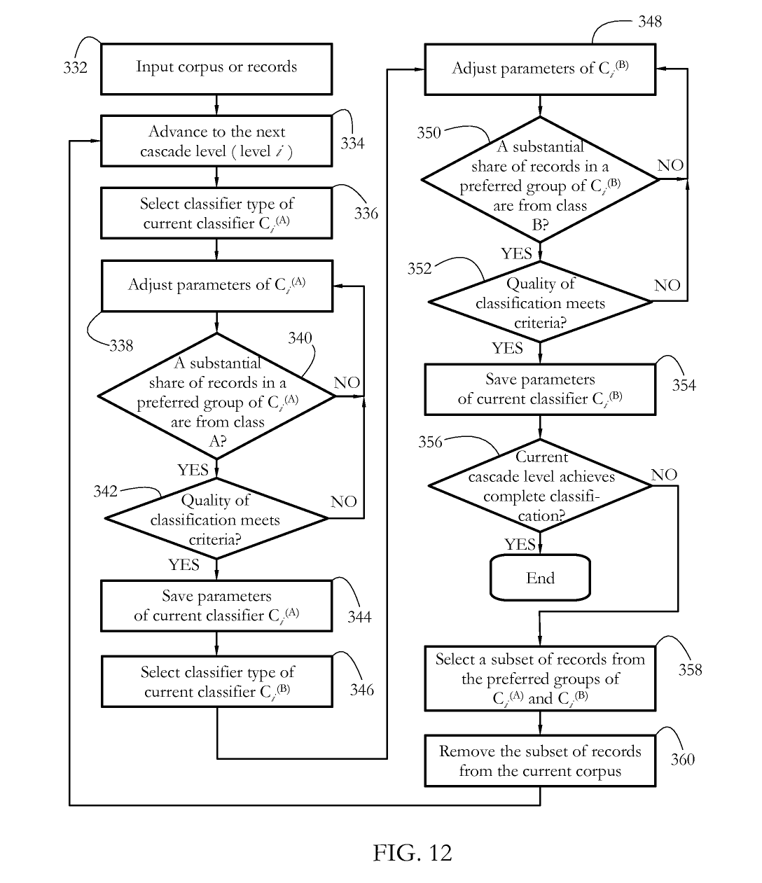

FIG. 12 shows an exemplary sequence of steps performed by trainer 42 (FIG. 4) to train a cascade of classifiers comprising multiple classifiers per level, according to some embodiments of the present invention. After inputting the training corpus (step 332), a sequence of steps 334-360 is repeated in a loop, each loop performed to train a separate level of the cascade. Again, the illustrated example shows training two classifiers per level, but the given description may be easily adapted to other configurations, without departing from the scope of the present invention.

After selecting a type of classifier Cᵢ^{(A)} (step 336), in a sequence of steps 338-340-342, trainer 42 trains classifier Cᵢ^{(A)} to distinguish a preferred group of records of which a substantial share (e.g., more than 99%) belong to class A. In addition, the trained classifier may be required to satisfy some quality criteria. For examples of such criteria, see above in relation to FIG. 6. When training criteria are satisfied, a step 344 saves parameters of classifier Cᵢ^{(A)}.

A sequence of steps 346-354 performs a similar training of classifier Cᵢ^{(B)}, with the exception that classifier Cᵢ^{(B)} is trained to distinguish a preferred group of records of which a substantial share (e.g., more than 99%) belong to class B. In a step 356, trainer 42 checks whether classifiers of the current level of the cascade completely classify the current training corpus. In the case of multiple classifiers per level, complete classification may correspond to a situation wherein all records of the current training corpus belonging to class A are in the preferred group of classifier Cᵢ^{(A)}, and all records of the current training corpus belonging to class B are in the preferred group of classifier Cᵢ^{(B)}. When yes, training stops.

When the current cascade level does not achieve complete classification, in a sequence of steps 358-360, trainer 42 may select a set of records from the preferred groups of classifiers Cᵢ^{(A)} and Cᵢ^{(B)}, and may remove such records from the training corpus before proceeding to the next level of the cascade.

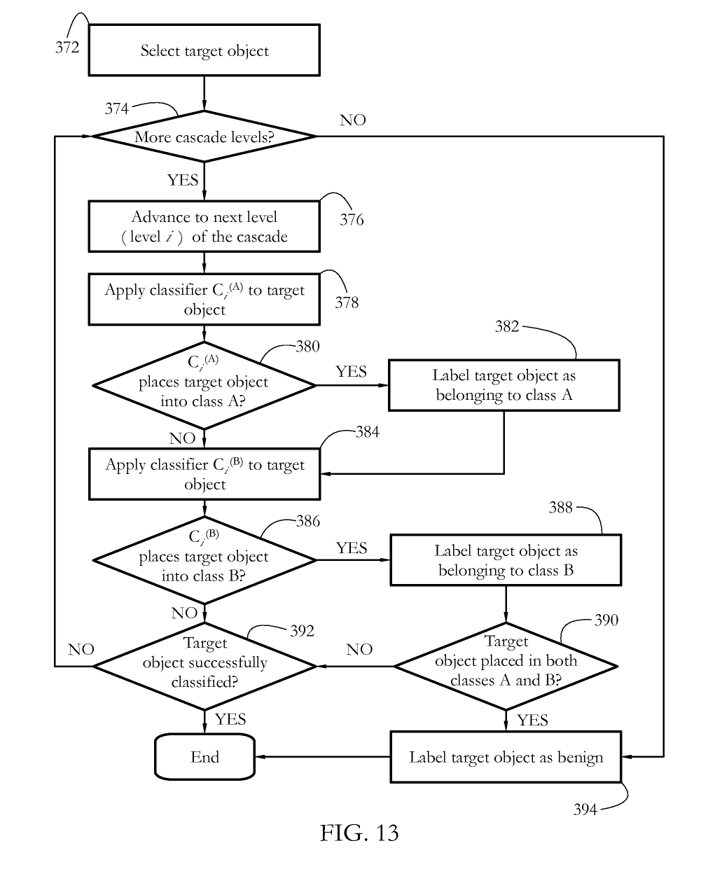

FIG. 13 illustrates an exemplary sequence of steps performed by security application 52 to use the trained cascade to classify an unknown target object, in an embodiment of the present invention wherein the cascade comprises multiple trained classifiers per level. A step 372 selects the target object (see also discussion above, in relation to FIG. 10). A sequence of steps 374-394 is repeated in a loop until a successful classification of the target object is achieved, each instance of the loop corresponding to a consecutive level of the cascade. Thus, in some embodiments, classifiers of the cascade are used for discovery in the order in which they were trained, i.e., respecting the order of their respective levels within the cascade.

A step 376 applies classifier Cᵢ^{(A)} to the target object. When Cᵢ^{(A)} places the target object into its preferred class (class A), a step 382 labels the target object as belonging to class A before advancing to a step 348. Step 384 applies another classifier of level i, e.g., classifier Cᵢ^{(B)}, to the target object. When classifier Cᵢ^{(B)} places the target object into its preferred class (class B), a step 388 labels the target object as belonging to class B. When no, a step 392 checks whether classifiers of the current cascade level have successfully classified the target object, e.g., as belonging to either class A or B. When yes, classification stops. When no classifier of the current cascade level has successfully classified the target object, security application 52 advances to the next cascade level (step 374). When the cascade contains no further levels, in a step 394, application 52 may label the target object as benign, to avoid a false positive classification of the target object. In an alternative embodiment, step 394 may label the target object as unknown.

A step 390 determines whether more than one classifier of the current level of the cascade has placed the target object within its preferred class (e.g., in FIG. 13, when both steps 380 and 386 have returned a YES). When no, security application 52 advances to step 392 described above. When yes, the target object may be labeled as benign or unknown, to avoid a false positive classification.

The exemplary systems and methods described above allow a computer security system to automatically classify target objects using a cascade of trained classifiers, for applications including, among others, malware detection, spam detection, and fraud detection. The cascade may include a variety of classifier types, such as artificial neural networks (ANNs), support vector machines (SVMs), clustering classifiers, and decision tree classifiers, among others. A pre-classified training corpus, possibly consisting of a large number of records (e.g. millions), is used for training the classifiers. In some embodiments, individual classifiers of the cascade are trained in a predetermined order. In the classification phase, the classifiers of the cascade may be employed in the same order they were trained.

Each classifier of the cascade may be configured to divide a current corpus of records into at least two groups so that a substantial proportion (e.g., all) of records within one of the groups have identical labels, i.e., belong to the same class. In some embodiments, before training a classifier from the next level of the cascade, a subset of the records in the respective group is discarded from the training corpus.

Difficulties associated with training classifiers on large, high-dimensional data sets are well documented in the art. Such training is computationally costly, and typically produces a subset of misclassified records. In computer security applications, false positives (benign records falsely identified as posing a threat) are particularly undesirable, since they may lead to loss of productivity and/or loss of data for the user. For instance, a computer security application may restrict access of the user to, or even delete a benign file wrongly classified as malicious. One conventional strategy of reducing misclassifications is to increase the sophistication of the trained classifiers and/or to complicate existing training algorithms, for instance, by introducing sophisticated cost functions that penalize such misclassifications.

In contrast, some embodiments of the present invention allow using basic classifiers such as a perceptron, which are relatively fast to train even on large data sets. Speed of training may be particularly valuable in computer security applications, which have to process large amounts of data (e.g., millions of new samples) every day, due to the fast pace of evolution of malware. In addition, instead of using a single sophisticated classifier, some embodiments use a plurality of classifiers organized as a cascade (i.e., configured to be used in a predetermined order) to reduce misclassifications. Each trained classifier of the cascade may be relied upon to correctly label records lying in a certain region of feature space, the region specific to the respective classifier.

In some embodiments, training is further accelerated by discarding a set of records from the training corpus in between training consecutive levels of the cascade. It is well known in the art that the cost of training some types of classifiers has a strong dependence on the count of records of the corpus (e.g., order N log N or N², wherein N is the count of records). This problem is especially acute in computer security applications, which typically require very large training corpuses. Progressively reducing the size of the training corpus according to some embodiments of the present invention may dramatically reduce the computational cost of training classifiers for computer security. Using more than one classifier for each level of the cascade may allow an even more efficient pruning of the training corpus.

Some conventional training strategies, commonly known as boosting, also reduce the size of the training corpus. In one such example know in the art, a set of records repeatedly misclassified by a classifier in training is discarded from the training corpus to improve the performance of the respective classifier. In contrast to such conventional methods, some embodiments of the present invention remove from the training corpus a set of records correctly classified by a classifier in training.

It will be clear to one skilled in the art that the above embodiments may be altered in many ways without departing from the scope of the invention. Accordingly, the scope of the invention should be determined by the following claims and their legal equivalents.

What is claimed is:

1. A computer system comprising a hardware processor and a memory, the hardware processor configured to employ a trained cascade of classifiers to determine whether a target object poses a computer security threat, wherein the cascade of classifiers is trained on a training corpus of records, the training corpus pre-classified into at least a first class and a second class of records, and wherein training the cascade comprises:
training a first classifier of the cascade to divide the training corpus into a first plurality of record groups according to a predetermined first threshold so that a first share of records of a first group of the first plurality of record groups belongs to the first class, the first share chosen to exceed the first threshold;
training a second classifier of the cascade to divide the training corpus, including the first group, into a second plurality of record groups according to a predetermined second threshold so that a second share of records of a second group of the second plurality of record groups belongs to the second class, the second share chosen to exceed the second threshold;
in response to training the first and second classifiers, removing a set of records from the training corpus to produce a reduced training corpus, the set of records selected from the first and second groups;
in response to removing the set of records, training a third classifier of the cascade to divide the reduced training corpus into a third plurality of record groups according to a predetermined third threshold so that a third share of records of a third group of the third plurality of record groups belongs to the first class, the third share chosen to exceed the third threshold; and
in response to removing the set of records, training a fourth classifier of the cascade to divide the reduced training corpus, including the third group, into a fourth plurality of record groups according to a predetermined fourth threshold so that a fourth share of records of a fourth group of the fourth plurality of record groups belongs to the second class, the fourth share chosen to exceed the fourth threshold.

2. The computer system of claim 1, wherein employing the trained cascade of classifiers comprises:
applying the first and second classifiers to determine a class assignment of the target object; and
in response to applying the first and second classifiers, when the target object does not belong to the first class according to the first classifier, and when the target object does not belong to the second class according to the second classifier, applying the third classifier to determine the class assignment of the target object.

3. The computer system of claim 2, wherein employing the trained cascade of classifiers further comprises:
in response to applying the first and second classifiers, when the target object belongs to the first class according to the first classifier, and when the target object does not belong to the second class according to the second classifier, assigning the target object to the first class;
in response to applying the first and second classifiers, when the target object does not belong to the first class according to the first classifier, and when the target object belongs to the second class according to the second classifier, assigning the target object to the second class; and
in response to applying the first and second classifiers, when the target object belongs to the first class according to the first classifier, and when the target object belongs to the second class according to the second classifier, labeling the target object as non-malicious.

4. The computer system of claim 1, wherein the first share of records is chosen so that all records of the first group belong to the first class.

5. The computer system of claim 1, wherein the set of records comprises all records of the first and second groups.

6. The computer system of claim 1, wherein the first class consists exclusively of malicious objects.

7. The computer system of claim 1, wherein the first class consists exclusively of benign objects.

8. The computer system of claim 1, wherein the first classifier is selected from a group of classifiers consisting of a perceptron, a support vector machine (SVM), a clustering classifier, and a decision tree.

9. The computer system of claim 1, wherein the target object is selected from a group of objects consisting of an executable object, an electronic communication, and a webpage.

10. A computer system comprising a hardware processor and a memory, the hardware processor configured to train a cascade of classifiers for use in detecting computer security threats, wherein the cascade is trained on a training corpus of records, the training corpus pre-classified into at least a first class and a second class of records, and wherein training the cascade comprises:
training a first classifier of the cascade to divide the training corpus into a first plurality of record groups according to a predetermined first threshold so that a first share of records of a first group of the first plurality of record groups belongs to the first class, the first share chosen to exceed the first threshold;
training a second classifier of the cascade to divide the training corpus, including the first group, into a second plurality of record groups according to a predetermined second threshold so that a second share of records of a second group of the second plurality of record groups belongs to the second class, the second share chosen to exceed the second threshold;
in response to training the first and second classifiers, removing a set of records from the training corpus to produce a reduced training corpus, the set of records selected from the first and second groups;
in response to removing the set of records, training a third classifier of the cascade to divide the reduced training corpus into a third plurality of record groups according to a predetermined third threshold so that a third share of records of a third group of the third plurality of record groups belongs to the first class, the third share chosen to exceed the third threshold; and
in response to removing the set of records, training a fourth classifier of the cascade to divide the reduced training corpus, including the third group, into a fourth plurality of record groups according to a predetermined fourth threshold so that a fourth share of records of a fourth group of the fourth plurality of record groups belongs to the second class, the fourth share chosen to exceed the fourth threshold.

11. The computer system of claim 10, wherein detecting computer security threats comprises:
applying the first and second classifiers to determine a class assignment of a target object evaluated for malice; and
in response to applying the first and second classifiers, when the target object does not belong to the first class according to the first classifier, and when the target object does not belong to the second class according to the second classifier, applying the third classifier to determine the class assignment of the target object.

12. The computer system of claim 11, wherein detecting computer security threats further comprises:
in response to applying the first and second classifiers, when the target object belongs to the first class according to the first classifier, and when the target object does not belong to the second class according to the second classifier, assigning the target object to the first class;
in response to applying the first and second classifiers, when the target object does not belong to the first class according to the first classifier, and when the target object belongs to the second class according to the second classifier, assigning the target object to the second class; and
in response to applying the first and second classifiers, when the target object belongs to the first class according to the first classifier, and when the target object belongs to the second class according to the second classifier, labeling the target object as non-malicious.

13. The computer system of claim 10, wherein the first share of records is chosen so that all records of the first group belong to the first class.

14. The computer system of claim 10, wherein the set of records comprises all records of the first and second groups.

15. The computer system of claim 10, wherein the first class consists exclusively of malicious objects.

16. The computer system of claim 10, wherein the first class consists exclusively of benign objects.

17. The computer system of claim 10, wherein the first classifier is selected from a group of classifiers consisting of a perceptron, a support vector machine (SVM), a clustering classifier, and a decision tree.

18. The computer system of claim 10, wherein the computer security threats are selected from a group of threats consisting of malicious software, unsolicited communication, and online fraud.

19. A non-transitory computer-readable medium storing instructions which, when executed by at least one hardware processor of a computer system, cause the computer system to employ a trained cascade of classifiers to determine whether a target object poses a computer security threat, wherein the cascade of classifiers is trained on a training corpus of records, the training corpus pre-classified into at least a first class and a second class of records, and wherein training the cascade comprises:
training a first classifier of the cascade to divide the training corpus into a first plurality of record groups according to a predetermined first threshold so that a first share of records of a first group of the first plurality of record groups belongs to the first class, the first share chosen to exceed the first threshold;
training a second classifier of the cascade to divide the training corpus, including the first group, into a second plurality of record groups according to a predetermined second threshold so that a second share of records of a second group of the second plurality of record groups belongs to the second class, the second share chosen to exceed the second threshold;
in response to training the first and second classifiers, removing a set of records from the training corpus to produce a reduced training corpus, the set of records selected from the first and second groups;
in response to removing the set of records, training a third classifier of the cascade to divide the reduced training corpus into a third plurality of record groups according to a predetermined third threshold so that a third share of records of a third group of the third plurality of record groups belongs to the first class, the third share chosen to exceed the third threshold; and
in response to removing the set of records, training a fourth classifier of the cascade to divide the reduced training corpus, including the third group, into a fourth plurality of record groups according to a predetermined fourth threshold so that a fourth share of records of a fourth group of the fourth plurality of record groups belongs to the second class, the fourth share chosen to exceed the fourth threshold.

20. The computer-readable medium of claim 19, wherein employing the trained cascade of classifiers comprises:
applying the first and second classifiers to determine a class assignment of the target object; and
in response to applying the first and second classifiers, when the target object does not belong to the first class according to the first classifier, and when the target object does not belong to the second class according to the second classifier, applying the third classifier to determine the class assignment of the target object.

21. The computer-readable medium of claim 20, wherein employing the trained cascade of classifiers further comprises:
in response to applying the first and second classifiers, when the target object belongs to the first class according to the first classifier, and when the target object does not belong to the second class according to the second classifier, assigning the target object to the first class;
in response to applying the first and second classifiers, when the target object does not belong to the first class according to the first classifier, and when the target object belongs to the second class according to the second classifier, assigning the target object to the second class; and
in response to applying the first and second classifiers, when the target object belongs to the first class according to the first classifier, and when the target object belongs to the second class according to the second classifier, labeling the target object as non-malicious.
